(19) United States
(12) Patent Application Publication
(10) Pub. No.: US 2011/0215561 A1
(43) Pub. Date: Sep. 8, 2011

(54) METHOD OF AUTHENTICATING A SECURITY DOCUMENT COMPRISING A THERMOCHROMIC ELEMENT AND DATA CONTAINING TEMPERATURE INFORMATION, AND ASSOCIATED SECURITY DOCUMENT

(75) Inventors: Henri Rosset, Le Pin (FR); Philippe Dietemann, Saint Martin d'Heres (FR)

(73) Assignee: ARJOWIGGINS SECURITY, PARIS (FR)

(21) Appl. No.: 13/125,731

(22) PCT Filed: Oct. 22, 2009
(86) PCT No.: PCT/IB2009/054682

§ 371 Date: May 19, 2011

(30) Foreign Application Priority Data
Oct. 22, 2008 (FR) 08 57163

(51) Int. Cl. B42D 15/00

(52) U.S. Cl. 283/70; 283/74

(57) ABSTRACT

Security document including at least one thermochromic element able to change appearance at at least one predefined temperature, and at least one indication on the document, associated with said at least one thermochromic element, giving information on the change-of-appearance temperature of said at least one thermochromic element.

The present invention relates to the field of security documents and concerns a security document comprising one or more thermochromic elements, especially liquid crystals or thermochromic pigments, an authentication method and a method of manufacturing this security document.

### BACKGROUND

To protect against counterfeit or false security documents and to increase the security level of documents, it is known to incorporate thermochromic elements therein, the appearance, for example the color, of which can be modified by a temperature change, or for which a temperature change possibly leads to the at least partial appearance or disappearance of one or more patterns. Application EP 1 072 438 describes for example a security document comprising a surface layer with liquid crystals the transparency of which varies as a function of temperature so as to make indications located beneath this surface layer progressively appear.

Patent EP 1 548 657 describes a banknote comprising a security pattern printed on the note using an ink comprising liquid crystals and gadolinium. Under the effect of a magnetic field the temperature of the gadolinium increases, and consequently the temperature of the liquid crystals as well, thereby causing the security pattern to change color.

The use of thermochromic elements in security documents allows different visual effects to be obtained on a security document, and is advantageous as much from the esthetic point of view as from that of document security.

Moreover, it is also known to use thermochromic elements, especially liquid crystals, for the manufacture of thin-film thermometers. Such thermometers may for example be used to measure body temperature or the temperature of various objects, for example a bottle of wine, and may take the form of labels.

U.S. Pat. No. 4,468,137, U.S. Pat. No. 4,338,139, U.S. Pat. No. 4,829,539, BE 817 183 and the applications GB 2 197 109, EP 0 997 717, ES 2 147 513 and GB 1 597 388 describe various thermometers using liquid crystals for measuring the temperature of various objects or room temperature, these thermometers generally being incorporated into labels not intended to serve as security elements.

### SUMMARY

There is a need to further reinforce the security and the authentication procedures of security documents, especially so as to make the counterfeiting of these documents harder.

One subject of the invention, according to one of its aspects, is a security document comprising:
a thermochromic element, or preferably thermochromic elements, especially liquid crystals and/or thermochromic pigments, able to change appearance at at least one predefined temperature; and
at least one indication on the document, associated with said thermochromic element, giving information on the change-of-appearance temperature of said thermochromic element.

By virtue of the invention, it is possible to confer on the security document a new functionality for its user. The indication may be directly understood by the user and may allow the latter to receive information on the temperature of an object, on room temperature and/or on body temperature depending on the environment in which the document is located. The latter may serve as a thermometer.

Moreover, comparison of the actual temperature of the environment in which the document is located, given for example by a reference thermometer, with the indication delivered by the document, may form an additional security element of the document.

It may prove to be difficult for a potential counterfeiter to reproduce exactly the thermochromic element or elements to the point that the appearance change takes place at a precise temperature and thus notable differences between the reading of a reference thermometer and the indication delivered by the document may allow it to be concluded that the security document is a counterfeit.

Moreover, the invention may provide a user with a simple and accessible means for knowing a temperature, for example room temperature or the temperature of an object on which the security document is applied, the security document possibly being for example an identity card, a passport or a banknote that the user is likely to carry on his person.

The appearance of the thermochromic element or elements, for example their color or their transparency, varies as a function of the temperature to which the thermochromic element or elements are subjected.

In the case of one or more thermochromic pigments, the appearance generally passes from a colored state to a colorless, for example transparent, state.

The process whereby the appearance of the thermochromic element or elements changes may be reversible or irreversible. Preferably the appearance change is reversible.

The thermochromic element or elements may all change appearance at one and only one predefined temperature, and the indication may give information on the one and only one change-of-appearance temperature of the thermochromic element or elements.

The change-of-appearance temperature of the thermochromic element or elements may for example lie between −20 and 50° C., for example between 0 and 40° C., even between 15 and 35° C. The change-of-appearance temperature may for example be higher than 10, even 15, even 20, even 25, even 30° C.

The change-of-appearance temperature of the thermochromic element or elements may for example be beyond the range of temperature values encountered for example in a given geographic region. The change-of-appearance temperature may for example be lower than −20° C. or higher than 50° C., preferably lower than −50° C. or higher than 100° C. Accordingly, the authentication may be carried out using a suitable system, thereby increasing the security level and the security of said document. Such a system may for example be a portable device or even one integrated into a sorting machine. It may comprise an element allowing a temperature to be applied such that the thermochromic element changes appearance, and optionally an element allowing said appearance change to be detected. The document is then authenticated by the user, for example by means of said portable device, especially by visual comparison with said indication, or by an additional element, especially an element designed for said system.

The thermochromic element or elements, especially in the case of thermochromic liquid crystals, may be placed on a black or dark background on the document. Accordingly, their visibility is improved.

The indication may be delivered by at least one part of the thermochromic element or elements. The document may especially comprise a plurality of thermochromic elements allowing different or identical indications to be delivered. For example, the document may comprise several thermochromic elements changing appearance at staggered temperatures, so as to allow a temperature measurement. The number of different temperatures signaled by the thermochromic elements may be higher than or equal to two, or better still, three or five, or even more.

The indication may be delivered by one or more elements of the document. For example, the indication may be delivered by an element located near to or removed from the thermochromic element or elements with which it is associated. The indication may be printed on, etched in or bonded onto the security document. The indication may be delivered by an element of the document, especially a security element, different from the thermochromic element or elements.

The indication may give quantitative and/or qualitative information on the change-of-appearance temperature of said at least one part of the thermochromic element or elements.

The indication may for example correspond to one or more patterns or images allowing the temperature to be qualitatively judged. For example an upwardly directed arrow “↑” may indicate a temperature higher than a reference temperature signaled elsewhere on the document, a downwardly directed arrow “↓” may indicate a lower temperature and an equals sign “=” may indicate a normal temperature. Any other symbol, pattern or image may be used.

The indication may give information on the numerical value of the change-of-appearance temperature of the thermochromic element or elements. For example, the indication may indicate if the temperature is higher or lower than a known threshold (or reference) temperature. The indication may also comprise a temperature range.

The indication may correspond to the numerical value of the change-of-appearance temperature of the thermochromic element or elements. In particular, the indication may be delivered by one or more alphanumeric characters, for example juxtaposed to or superposed on the thermochromic element or elements or else formed by the placing the thermochromic element or elements so that, for example, the indication appears as a negative when the appearance of the thermochromic element or elements changes. The indication may appear in the form of figures and/or letters when the thermochromic element or elements with which it is associated change(s) appearance. These figures and/or letters may directly indicate the value of the change-of-appearance temperature of the thermochromic element or elements with which the indication is associated.

The indication may also be delivered by the pattern or patterns formed by the thermochromic element or elements at the change-of-appearance temperature, the indication thus possibly appearing as a positive pattern when the appearance of the thermochromic element or elements changes. In particular, the thermochromic element or elements may be arranged in the form of alphanumeric characters and/or in the form of symbols, patterns or images, possibly giving qualitative and/or quantitative information on the temperature.

The security document may also comprise at least one security element different to the thermochromic element or elements.

Among security elements, certain are detectible with the naked eye, under visible light, without using a particular piece of equipment. These security elements comprise for example a watermark, fibers or colored planchettes, printed, metallized or holographic threads, holographic foils or printing having optically variable effects.

These security elements are called first-level security elements.

Other types of security element are detectable only using a relatively simple piece of equipment such as a lamp emitting in the ultraviolet or infrared. These security elements comprise for example fibers, planchettes, strips, threads or particles. These security elements may or may not be visible to the naked eye, being for example luminescent under an ultraviolet (UV) or infrared (IR) illumination. These security elements are called second-level security elements.

Other types of security element moreover require for their detection a more sophisticated piece of equipment. These security elements are for example capable of generating a specific signal when they are subject, whether simultaneously or not, to one or more external excitation signals. The automatic detection of the signal allows the document to be authenticated, as required.

These security elements comprise for example tracers that take the form of an active material, particles or fibers, capable of generating a specific signal when these tracers are subject to an optronic, electrical, magnetic or electromagnetic signal.

These security elements are called third-level security elements.

The security elements borne by the security document may be of first-, second- and/or third-level security elements.

The security elements may especially be chosen from tracers, especially nanoscale tracers, security fibers, especially metallic, magnetic (whether magnetically soft and/or hard), or absorbent fibers or fibers that are excitable in the ultraviolet (UV), visible or infrared (IR) and in particular in the near infrared (NIR), flat relatively small-format security elements such as planchettes, pigments or agglomerates of pigments that are in particular absorbent or excitable under laser illumination in the ultraviolet (UV), visible or infrared (IR), in particular in the near infrared (NIR), and security threads (based on plastics, especially polyester) particularly being at least partially coated with a metal, metallized, iridescent or magnetic (whether magnetically soft and/or hard) coating, the coating in particular possibly comprising positive or negative patterns and said patterns in particular possibly being obtained by demetallization, the falsification-revealing and/or authenticating and/or identifying chemical or biochemical reactants in particular possibly reacting with at least one falsification-revealing and/or authenticating and/or identifying agent, respectively, and optically variable elements especially holograms, liquid crystals, iridescent pigments or mirror-effect structures, in particular dielectrics and their combinations.

The security document may in particular comprise an electronic device, especially an integrated microcircuit, for example an RFID device.

The indication giving information on the change-of-appearance temperature of the thermochromic element or elements may be stored in an electronic device present on the document. A user may for example observe an appearance change in the thermochromic element or elements and use an external reader to read data contained in the electronic device so as to obtain information on the change-of-appearance temperature of the thermochromic element or elements.

The security document may comprise a graduated temperature scale, especially in an international system (SI) unit, for example in degrees Celsius (° C.) and/or degrees Fahrenheit (° F.). The thermochromic element or elements may be juxtaposed to or superposed on this scale.

At least one part of the thermochromic element or elements, serving to indicate the temperature and/or the indication, may be borne by a temperature-indicating element incorporated into the document.

The temperature-indicating element may be a foil, a patch or preferably a security thread.

The temperature-indicating element may extend from one edge of the security document to the other, especially along the width and/or the length of the security document.

The temperature-indicating element may comprise one or more layers, especially polymer layers. The layers may be laminated to one another. For example, the temperature-indicating element may comprise a bottom layer, for example made of a partially or completely black or dark-colored PET film and an intermediate layer comprising one or more thermochromic elements, especially thermochromic liquid crystals, whether or not comprising recesses for example in the form of patterns.

Said temperature-indicating element optionally furthermore comprises a continuous or discontinuous top layer comprising for example a demetallized region or regions, in the form of patterns, especially figures, corresponding to the indication(s) associated with the thermochromic element or elements

Said temperature indicator element optionally furthermore comprises a continuous or discontinuous top layer comprising for example interference-effect elements, especially liquid crystals having an interference effect when located above a black or dark-colored layer or element, for example cholesteric liquid crystals.

Thus, in one example, the temperature-indicating element comprises a black or dark-colored layer, a liquid-crystal thermochromic element on the black or dark-colored layer and a cholesteric-liquid-crystal top layer covering the thermochromic element and the black or dark-colored layer.

The expression “dark-colored” is understood to mean a color that is sufficiently dark to make viewing of the thermochromic element or elements, especially thermochromic liquid crystals, easier.

The temperature-indicating element may be combined with at least one additional security element of the security document, for example a luminescent, especially fluorescent and/or phosphorescent, interference, holographic or magnetically coded, security element inter alia.

The temperature-indicating element may consist of or be placed on a transparent window in the security document.

The temperature-indicating element may be completely incorporated into the security document, especially within the thickness, or partially incorporated thereinto, especially in one or more windows. In particular, the temperature-indicating element may be a security thread incorporated into the thickness of, or into one or more windows in, the security document.

The temperature-indicating element is preferably incorporated into one or more windows in the document, especially so as to allow the temperature-indicating element to be more easily seen and to allow better retention in the security document. The temperature-indicating element is then located on the surface of the security document and within the thickness of the latter, for example alternately. In particular, the windows thus formed may be through-windows or blind windows, depending on whether the temperature-indicating element appears respectively on both sides or on only one side of the security document. The introduction of a security thread into one or more windows in a single ply is for example described in patent applications EP 059 056 for a cylinder mold paper machine and EP 0 609 252 for a Fourdrinier paper machine. The introduction into one or more windows between two plies of a multiply fibrous material is described in patent application EP 0 229 645.

The thermochromic element or elements may be printed on the document and/or on the temperature-indicating element, especially using screen printing.

The thermochromic element or elements may or may not be micro-encapsulated.

The temperature-indicating element may comprise one or more layers.

The temperature-indicating element may comprise a layer forming a black or dark-colored background, for example a bottom layer of the temperature-indicating element, above which are the thermochromic element or elements. For example, the temperature-indicating element may comprise a black or dark-colored film, for example a polyester or polyethylene terephthalate (PET) film, produced for example by pigmentation of the bulk or by application of a black or dark-colored coating onto the film. Said black or dark-colored film may also be produced by printing onto the temperature-indicating element. The expression “dark-colored” is understood to mean a color that is sufficiently dark to make viewing of the thermochromic element or elements, especially thermochromic liquid crystals, easier.

The temperature-indicating element may also comprise a transparent layer, for example a top layer of the temperature-indicating element, beneath which are the thermochromic element or elements. The transparent layer may be a transparent polyester film. The external face of the temperature-indicating element, especially the transparent layer, may be coated with a uniform layer having a superficial visual effect such as a change of appearance, especially color, depending on the viewing angle, for example using one or more goniochromatic thermochromic elements or using, for example, cholesteric liquid crystals having an interference effect when located above a black or dark-colored layer or element. The external face may also be defined by microreliefs forming a diffraction grating.

The top layer may also correspond to a metallized layer, for example an aluminum-comprising polyester film, this layer having demetallized regions allowing the indication associated with the thermochromic element or elements to appear as a positive or as a negative pattern. In particular, the top layer may comprise metallizations and/or demetallizations in the form of figures representing one or more indications associated with the thermochromic element or elements.

The thermochromic element or elements may be applied on one of the faces of a bottom and/or top layer of the temperature-indicating element, for example such as defined above.

The temperature-indicating element may comprise one or more adhesive layers for ensuring the cohesion of the layers, which make up this element, to one another.

The temperature-indicating element may also comprise at least twice the same temperature range, especially when it is introduced into windows in the document. Accordingly, it is possible to observe at least once all the temperatures in the temperature range on the document, even if some temperatures are masked by document bridges formed between the windows.

The temperature-indicating element may comprise one or more security elements such as those mentioned above for the security document.

The document and/or the temperature-indicating element may be configured to indicate a plurality of temperatures, with a constant or variable interval, in the same unit or in different units. The temperatures indicated may for example allow body temperature to be known, being for example the following: 37-38-39-40° C. The temperatures indicated may also depend on the climate of the country concerned, especially when the document is used to measure room temperature.

The document and/or the temperature-indicating element may comprise a substrate comprising paper fibers known to a person skilled in the art, for example cellulose fibers (in particular cotton fibers) and/or natural organic fibers other than cellulose fibers and/or synthetic fibers, for example such as polyester or polyamide fibers, and/or optionally mineral fibers, for example such as glass fibers.

The security document may be a passport, an identity card, a driving license, an access card, a loyalty card, a photocopier card, a canteen card, a playing card, a collectable card, a means of payment, especially a bank card, a purchased goods item or a receipt, an entrance ticket to a sporting or cultural event or a certificate of authenticity. Preferably the security document is a banknote.

Another subject of the invention, according to another of its aspects, is a method of authenticating a document as defined above, in which:
the indication giving information on the change-of-appearance temperature of the thermochromic element or elements is compared with the change-of-appearance temperature of the thermochromic element or elements, this temperature possibly being obtained in particular using a reference thermometer.

Another subject of the invention, independently of or in combination with the above, is a method of authenticating a security document, comprising:
at least one thermochromic element able to change appearance at least at one predefined temperature; and
at least one indication on the document, associated with said at least one thermochromic element, giving information on the change-of-appearance temperature of said at least one thermochromic element,
   in which method:
the indication giving information on the change-of-appearance temperature of said at least one thermochromic element is compared with the actual change-of-appearance temperature of said at least one thermochromic element, this temperature possibly being obtained in particular using a reference thermometer.

This comparison allows the authenticity of the document to be confirmed.

For example, the document may be considered to be authentic when the indication delivered by the document corresponds to the actual change-of-appearance temperature of the thermochromic elements, for example to within 10%, or better still to within 5%.

Another subject of the invention, independently of or in combination with the above, is a security document using the authentication method such as defined above.

Another subject of the invention, according to another of its appearances, is a method of manufacturing a security document, especially such as defined above, in which a substrate has incorporated into it a temperature-indicating element comprising:
a thermochromic element or thermochromic elements able to change appearance at a predefined temperature; and
at least one indication, associated with the thermochromic element or elements, giving information on the change-of-appearance temperature of the thermochromic element or elements.

The temperature-indicating element is for example a foil, a patch or a security thread.

The temperature-indicating element may be, or be placed on, a transparent window in the substrate.

The temperature-indicating element may be completely or partially incorporated into the substrate, especially in one or more windows.

Another object of the invention, independently of or in combination with the above, is a security document comprising:
a temperature-indicating element extending from one edge of the security document to the other and comprising at least one thermochromic element able to change appearance at a predefined temperature; and
at least one indication associated with said at least one thermochromic element, giving information on the change-of-appearance temperature of said at least one thermochromic element.

Another subject of the invention, independently of or in combination with the above, is a security document comprising:
one or more thermochromic elements all changing appearance at one and only one predefined temperature;
at least one indication on the document, associated with the thermochromic element or elements, giving information on the one and only one change-of-appearance temperature of the thermochromic element or elements.

The invention will possibly be better understood on reading the following detailed description of nonlimiting examples of methods of implementing the latter, and on examining the appended partial, schematic drawings, in which:

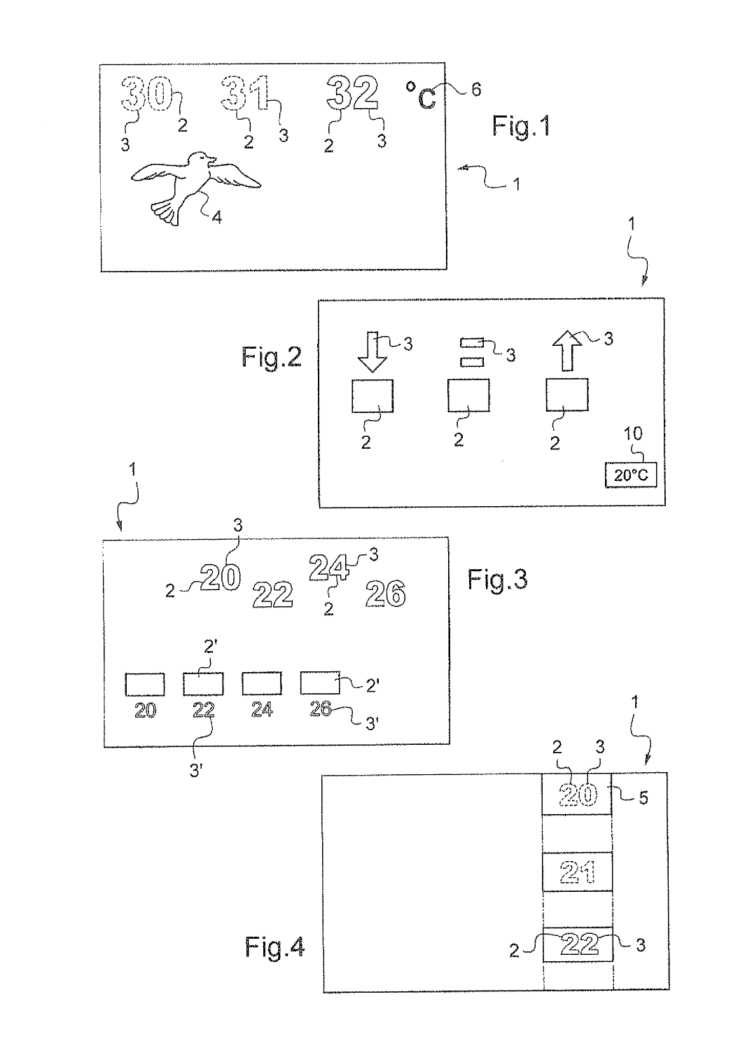

FIGS. 1 to 4 show front views of exemplary security documents according to the invention;

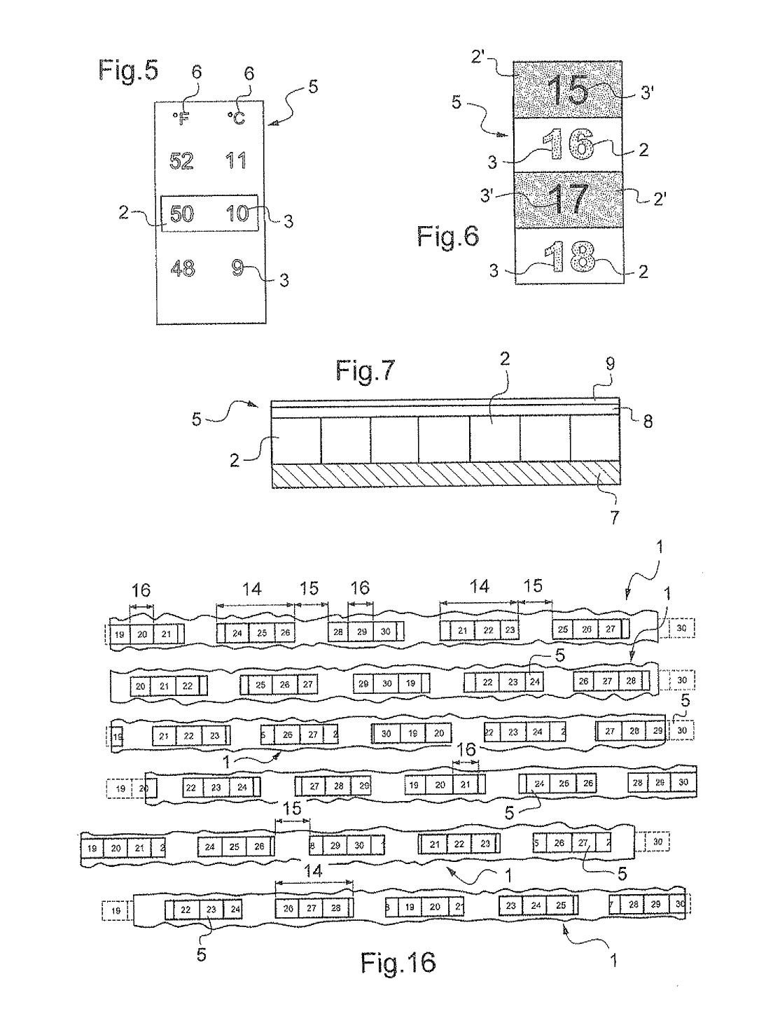

FIGS. 5 and 6 show front views of variants of embodiment of a temperature-indicating element of a document according to the invention;

FIG. 7 shows, in cross section, an example of a temperature-indicating element of a document according to the invention;

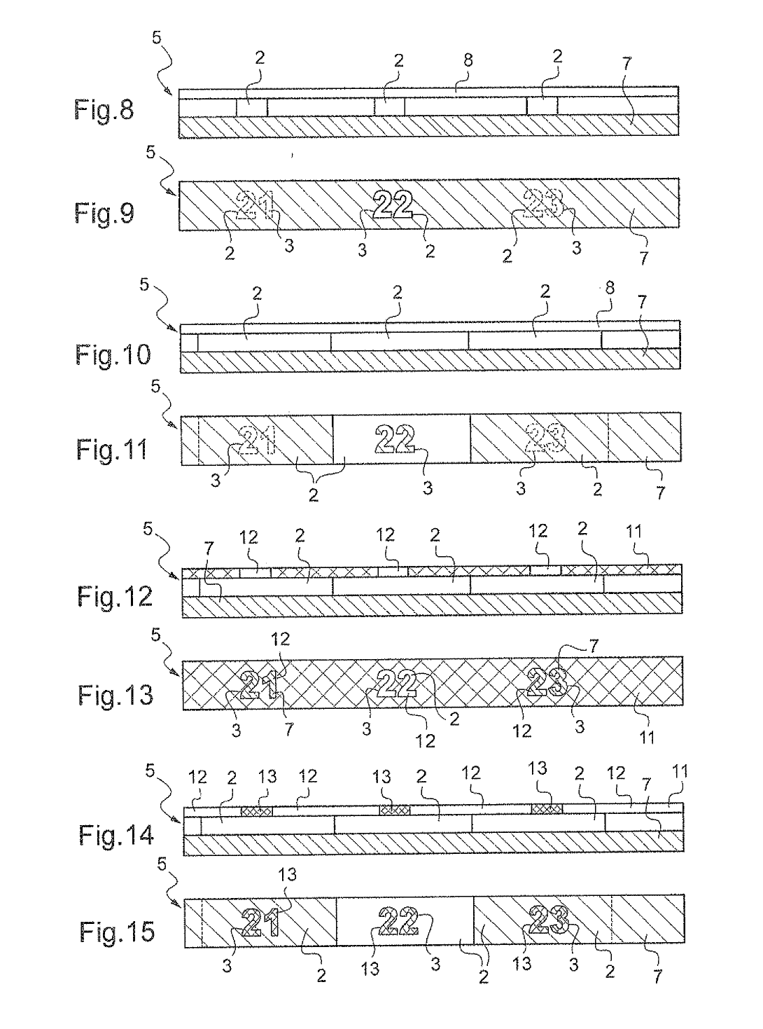

FIGS. 8, 10, 12 and 14 show, in cross section, other exemplary temperature-indicating elements of a document according to the invention comprising thermochromic liquid crystals;

FIGS. 9, 11, 13 and 15 show front views of the exemplary temperature indicators in FIGS. 8, 10, 12 and 14, respectively;

FIG. 16 shows several other examples of documents according to the invention, each comprising a temperature-indicating element introduced in one or more windows; and

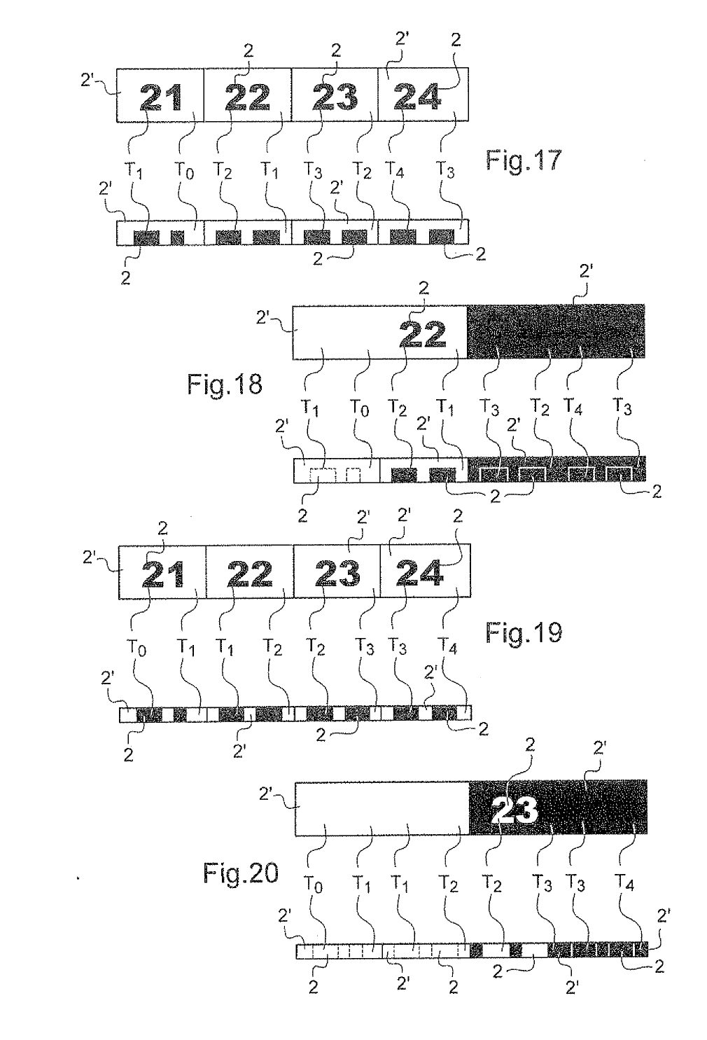

FIGS. 17 to 20 show, partially, other variants of structures possibly featuring on temperature-indicating elements or documents according to the invention and comprising thermochromic pigments.

In the drawings, the relative proportions between the various elements shown are not always to scale, for the sake or clarity.

An exemplary document 1 according to the invention is shown in FIG. 1.

The document 1 comprises thermochromic elements 2, especially thermochromic liquid crystals and/or thermochromic pigments, arranged on the document 1 in patterns forming figures. Thus, the thermochromic elements 2 are associated with a plurality of indications 3 which correspond to the numerical values or the respective change-of-appearance temperatures of the thermochromic elements 2.

In this example in particular, part of the thermochromic elements 2 is visible depending on the temperature to which the document 1 is subject.

The document 1 further comprises an icon 6 which indicates that the temperatures are here given in degrees Celsius (° C.). Thus in this example, a temperature of 32° C. may be read.

The document 1 may comprise any other security element 4 different from the thermochromic elements 2, for example a watermark.

Another exemplary document 1 according to the invention is shown in FIG. 2.

In this example, the document 1 comprises three regions, comprising thermochromic elements 2, respectively associated with three indications 3 in the form of symbols enabling information to be given on the change-of-appearance temperature of the thermochromic elements 2. The three indications 3, in the form of “↑”, “=” and “↓” symbols, allow for example for it to be indicated that the appearance change temperature of the corresponding thermochromic elements 2 is substantially higher, equal to or lower, respectively, than a reference temperature 10 indicated elsewhere on the document 1.

In this example, all the thermochromic elements 2 are visible on the document 1, but each indication 3 is associated with the corresponding thermochromic elements 2 changing color. As a variant, only the thermochromic elements the change-of-appearance temperature of which has been reached are visible.

Another exemplary document 1 according to the invention is shown in FIG. 3.

In this example, the document 1 comprises both thermochromic elements 2 arranged on the document 1 in patterns corresponding to indications 3 in the form of figures, and thermochromic elements 2′ associated with the indications 3′ in the form of figures, separate from the thermochromic elements 2.

Thus, it is possible to obtain two indications of the temperature of the security document 1, by virtue of the indications 3 and 3′, these indications possibly corresponding to the same temperature sequence.

In this example, the appearance change as a function of the temperature of the thermochromic elements 2 and 2′ corresponds to these thermochromic elements 2 and 2′ changing color.

Another exemplary document 1 according to the invention is shown in FIG. 4.

In this example, the document 1 comprises a temperature-indicating element 5, incorporated into windows in the document 1 so that the temperature is more easily viewed. The incorporation into windows may be carried out using any technique for incorporating a, security thread, for example insertion between two plies of paper.

The temperature-indicating element 5 comprises thermochromic liquid crystals 2 associated with indications 3 in the form of figures.

In this example, the thermochromic liquid crystals 2 may be seen only when the temperature applied to the document 1 corresponds to the change-of-appearance temperature of these thermochromic liquid crystals 2.

Two exemplary embodiments of temperature-indicating elements 5 of documents 1 according to the invention are shown in FIGS. 5 and 6.

In FIG. 5, the temperature-indicating element 5 comprises two temperature sequences 6 in degrees Fahrenheit (° F.) and in degrees Celsius (° C.), respectively.

The temperature sequences show indications 3 of the temperature of the document 1.

In this example, the thermochromic liquid crystals 2 appear in the form of a region encircling the indications 3 with which they are associated when their change-of-appearance temperature is reached.

In FIG. 6, the temperature-indicating element 5 comprises, in succession, thermochromic liquid crystals 2 associated with indications 3 in the form of figures, and thermochromic liquid crystals 2′ placed in regions on which indications 3′ feature, formed by elements other than thermochromic liquid crystals, for example printed elements.

Another exemplary temperature-indicating element 5 is shown in cross section in FIG. 7.

The temperature-indicating element 5 comprises a bottom layer 7 made for example of a black or dark-colored polyester film, an intermediate layer comprising thermochromic liquid crystals 2 and a transparent top layer 8, for example a transparent polyester film.

The transparent layer 8 may optionally, as illustrated, be coated with a uniform layer, providing the temperature-indicating element 5 with a superficial visual effect, for example changing color as a function of the viewing angle.

On the temperature-indicating element, thermochromic liquid crystals 2 may be applied by any suitable means, for example by screen printing, either on the internal face of the bottom layer 7, or on the internal face of the top layer 8.

One or more adhesive layers, not shown, may be applied between the various layers of the temperature-indicating element 5, so as to ensure cohesion.

Another exemplary temperature-indicating element 5 of a document according to the invention is shown in FIG. 8, in cross section, and in FIG. 9, viewed from the front.

In this example, the temperature-indicating element 5 comprises a bottom layer 7 made for example of a black polyethylene terephthalate (PET) film, an intermediate layer comprising thermochromic liquid crystals 2 and a transparent top layer 8, for example a transparent polyester film.

The thermochromic liquid crystals 2 associated with the indications 3 are arranged in the form of figures, as may be seen in FIG. 9. Thus, when the predefined temperature is reached, the corresponding thermochromic liquid crystals 2, and the indication 3 which is associated with them, appear as a positive pattern giving information on the change-of-appearance temperature of these thermochromic liquid crystals 2, thereby for example limiting the cost of an ink used for printing the indications 3, for example.

Thus, in this example, as may be seen in FIG. 9, only the indication “22” appears on the temperature-indicating element 5, corresponding for example to the fact that room temperature is 22° C. Outside of this region represented by the number “22”, only the lower layer 7 may be seen, including in the regions of thermochromic liquid crystals 2 representing the numbers “21” and “23”.

Another exemplary temperature-indicating element 5 of a document according to the invention is shown in FIG. 10, in cross section, and in FIG. 11, viewed from the front.

In this example, the thermochromic liquid crystals 2 are arranged in rectangular patterns so as to allow their associated indications 3 to appear as positive or negative figures, thereby also enabling the temperature range to be more easily viewed for example by offering a larger viewing area to the observer.

Thus, as may be seen in FIG. 11, only the thermochromic liquid crystals 2 associated with the indication of the number “22” are visible, thereby corresponding for example to a room temperature of 22° C. Outside of this region comprising the thermochromic liquid crystals 2 associated with the indication 3 in the form of the number “22”, only the bottom layer 7 may be seen, including in the regions comprising the thermochromic liquid crystals 2 and their associated indications 3 representing the numbers “21” and “23”. In this way the visibility of the indication 3 representing the number “22” may be improved.

Another exemplary temperature-indicating element 5 according to the invention is shown in FIG. 12, in cross section, and in FIG. 13, viewed from the front.

As may be seen in FIG. 12, the temperature-indicating element 5 may comprise a bottom layer 7 made for example of a black PET film, an intermediate layer comprising thermochromic liquid crystals 2, for example in the form of full rectangular patterns, and a top layer 11, for example made of an aluminum-comprising polyester film, having demetallized regions 12 in the form of figures which correspond to the indications 3 associated with the thermochromic liquid crystals 2.

Thus, as may be seen in FIG. 13, when room temperature is for example 22° C., only the thermochromic liquid crystals 2 associated with the indication 3 and the demetallized region 12 which represent the number “22” may be seen. The thermochromic liquid crystals 2 associated with the indications 3 representing the numbers “21” and “23” may not be seen and the bottom layer 7 is directly observable in the regions of these indications 3. However, outside of the regions associated with the indications 3 representing the numbers “21”, “22” and “23”, the top layer 11 may be seen, thereby allowing the numbers “21” and “23” to be seen, even if their associated thermochromic liquid crystals 2 may not.

Another variant embodiment of a temperature-indicating element 5 of a document according to the invention is shown in FIG. 14, in cross section, and in FIG. 15, viewed from the front.

In this example, in contrast to the variant embodiment shown in FIGS. 12 and 13 above, the temperature-indicating element 5 comprises a top layer 11 comprising demetallized regions 12 produced so that metallized regions 13 can be created in the form of figures corresponding to the indications 3 associated with the thermochromic liquid crystals 2.

Thus, when the temperature corresponds for example to 22° C., the thermochromic liquid crystals 2 associated with the indication 3 representing the number “22” are the only ones that may be seen, as is shown in FIG. 15. However, the indications 3 and the metallized regions 13 associated with the numbers “21” and “23” may also be seen, because of the metallization of these regions. Outside of the metallized regions 13 representing the numbers “21”, “22” and “23” and of the thermochromic liquid crystals 2 associated with the indication 3 which represents the number “22”, only the bottom layer 7 may be seen.

The top layers 8 or 11 may be coated with a uniform layer providing the temperature-indicating elements 5 with a superficial visual effect, as described in relation to the example of FIG. 7.

The thermochromic liquid crystals 2 may be applied by any suitable means, for example by screen printing, onto the internal face of the bottom layer 7 or onto the internal face of the top layer 8 or 11.

One or more adhesive layers may also be applied between the various layers of the temperature-indicating elements 5, so as to ensure their cohesion.

Several exemplary documents 1 according to the invention, each comprising a temperature-indicating element 5, incorporated into one or more windows, are shown in FIG. 16. The incorporation in one or more windows may be achieved using all the techniques described above.

For the sake of ease of comprehension, FIG. 16 shows part of the documents 1, in the region of the temperature-indicating elements 5.

The temperature-indicating elements 5 may be such as those described above. In particular, they may correspond to a security thread having a width for example of 4 mm and a length for example of 7 cm.

Preferably, the temperature-indicating elements 5 comprise two complete temperature ranges, for example the “19-30° C.” temperature range twice, and the length of the two temperature ranges preferably corresponds to the width of the document 1, for example a banknote. The choice of the temperature ranges may especially depend on the climate of the relevant country.

The temperature-indicating elements 5 may moreover be introduced into the documents 1, for example security sheets, during their manufacture without requiring introduction in registration.

As may be seen more particularly in FIG. 16, the introduction of temperature-indicating elements into one or more windows in the documents 1 may be carried out so as to produce windows 14, having a length for example of 9 mm, and bridges 15 between the windows 14, for example having a length equal to 4 mm. The temperature-indicating elements 5 may comprise units 16 in succession in which the indications 3 associated with the thermochromic elements 2 figure. The length of each of the units may for example be equal to 3 mm.

Thus, as may be observed in FIG. 16, because each of the temperature-indicating elements 5 comprises two temperature ranges, each unit comprising an indication 3 associated with the thermochromic elements 2 may be seen in at least one window 14, thereby compensating for the units 16, masked by the bridges 15, which cannot be seen.

Other examples of structures that may feature on the temperature-indicating elements of documents according to the invention or directly on the documents according to the invention are partially shown in FIGS. 17 to 20.

The security document according to the invention may comprise one or more thermochromic elements in the form of thermochromic pigments. The use of thermochromic pigments instead of the thermochromic liquid crystals may especially allow observation using light transmitted by these thermochromic pigments, in contrast to the liquid crystals which generally require a dark, in particular black, background in order to be seen. Also, when the security document comprises a temperature-indicating element, the use of one or more thermochromic pigments on the temperature-indicating element may allow the temperature-indicating element to be completely incorporated into the security document, especially within the thickness, especially in the form of a thread. In contrast, the use of one or more thermochromic elements in the form of thermochromic liquid crystals requiring a dark, in particular black, background to be seen, may require that the temperature-indicating element be incorporated into one or more windows in the security document.

The complete incorporation, especially within the thickness, of the temperature-indicating element comprising one or more thermochromic pigments is simpler to produce than the incorporation into one or more windows, and the temperature-indicating element, especially in the form of a thread, is more discreet, especially less visible, during the authentication of the security document. In particular, the pattern or patterns formed by the thermochromic pigment or pigments, especially in the form of figures, may be seen only in transmitted light and may not be seen in reflected light. The pattern or patterns formed may be produced using metallizations and/or demetallizations, for example, on the temperature-indicating element, for example, as one or more positive and/or negative patterns, The use of thermochromic pigments may furthermore allow a high contrast to be obtained when the thermochromic pigment or pigments are observed at the change-of-appearance temperature and may allow the use of a pattern or patterns that are smaller relative to the use of thermochromic liquid crystals.

Preferably, the thermochromic pigments used are such that they are colored before their appearance change at a predefined temperature and then colorless after their appearance change.

FIGS. 17 and 18 show an embodiment in which first thermochromic pigments 2 are arranged in the form of figures, representing for example the temperatures 21, 22, 23 and 24, and second thermochromic pigments 2′ are arranged in rectangular patterns covering these first thermochromic pigments 2.

The first and second thermochromic pigments 2 and 2′ change appearance at different temperatures T₀=21° C., T₁=22° C., T₂=23° C., T₃=24° C. and T₄=25° C. according to an arrangement shown in FIG. 17.

The thermochromic pigments 2 and 2′ may have the same post-appearance-change color, while changing appearance at different temperatures. As a variant, the thermochromic pigments 2 and 2′ may have different post-appearance-change colors but with decreasing intensities, i.e. the color of the pigments associated with T₀ is more intense than that of the pigments associated with T₁, itself more intense than the color of the pigments associated with T₂, etc. Thus, the second thermochromic pigments 2′, after having changed appearance, can mask the first thermochromic pigments 2.

FIG. 18 shows for example the structure observable when the temperature applied to the document comprising this structures lies between 22 and 23° C.

The thermochromic pigments 2 and 2′ associated with the temperatures T₀ and T₁ are colorless whereas the thermochromic pigments 2 and 2′ associated with the temperatures T₂ to T₄ are colored with decreasing intensities, thereby allowing a temperature of 22° C. to be seen as a positive pattern.

FIGS. 19 and 20 show a variant embodiment of the example in FIGS. 17 and 18, allowing the temperature applied to the document to be read as a negative pattern.

The thermochromic pigments 2′ are juxtaposed with the thermochromic pigments 2 in an arrangement shown in FIGS. 19 and 20. The thermochromic pigments for example have the same color after their appearance change but different appearance change temperatures: T₀=21° C., T₁=22° C., T₂=23° C., T₃=24° C. and T₄=25° C.

FIG. 20 for example shows the observable structure when the temperature applied to the document comprising this structure lies between 23 and 24° C. The thermochromic pigments 2 and 2′ associated with the temperatures T₀ to T₂ are colorless whereas the thermochromic pigments 2 and 2′ associated with the temperatures T₃ and T₄ are colored, thereby allowing a temperature of 23° C. to be seen as a negative pattern.

In all the examples described above, various visual effects may be combined with the temperature-indicating elements 5, for example interference, fluorescence or phosphorescence effects, magnetic coding or holographic effects.

The security document according to the invention and/or the temperature-indicating element that it comprises may for example comprise a fluorescent layer at least partially superposed on the thermochromic element or elements, especially having the form of one or more thermochromic pigments. The thermochromic element or elements may for example be produced as a negative pattern, as shown in FIG. 20, so that the temperature or temperatures revealed during the appearance change of the thermochromic element or elements fluoresce under an ultraviolet (UV) illumination. In the case of a temperature-indicating element, especially in the form of a thread, completely incorporated, especially within the thickness, into the security document and comprising such a fluorescent layer, the latter allows the temperature or temperatures revealed to be observed in reflected light, in addition to observation in transmitted light.

In all the examples described above, the authentication may be carried out manually, by subjecting the document to a reference temperature and verifying that the corresponding appearance change is produced. The authentication may also be carried out automatically by a machine, for example using an optical recognition device. In this case, the indication corresponding to the appearance change of the thermochromic elements may be encoded on the document.

The expression “comprising a” is synonymous with expression “comprising at least one”.

1-19. (canceled)

20. A method of authenticating a security document, the security document comprising:
at least one thermochromic element able to change appearance at least at one predefined temperature; and
at least one indication on the document, associated with said at least one thermochromic element, giving information on the change-of-appearance temperature of said at least one thermochromic element, the method comprising:
comparing the indication giving information on the change-of-appearance temperature of said at least one thermochromic element with the actual change-of-appearance temperature of said at least one thermochromic element.

21. The method as claimed in claim 20, said actual change-of-appearance temperature of said at least one thermochromic element being obtained using a reference thermometer.

22. The method as claimed in claim 20, the indication being delivered by said at least one thermochromic element.

23. The method as claimed in claim 20, the indication being delivered by one or more elements of the document, these being different from said at least one thermochromic element.

24. The method as claimed in claim 20, said at least one thermochromic element comprising thermochromic liquid crystals.

25. The method as claimed in claim 20, said at least one thermochromic element comprising thermochromic pigments.

26. The method as claimed in claim 20, the indication giving information on the numerical value of the change-of-appearance temperature of said at least one thermochromic element.

27. The method as claimed in claim 26, the indication corresponding to the numerical value of the change-of-appearance temperature of said at least one thermochromic element.

28. The method as claimed in claim 20, the indication being delivered, by the pattern or patterns formed by said at least one thermochromic element, at the change-of-appearance temperature.

29. The method as claimed in claim 20, the indication being delivered by one or more alphanumeric characters.

30. The method as claimed in claim 20, the security document comprising at least one security element different from said at least one thermochromic element.

31. The method as claimed in claim 20, the security document comprising a graduated temperature scale.

32. The method as claimed in claim 20, said at least one thermochromic element and/or the indication being borne by a temperature-indicating element incorporated into the document.

33. The method as claimed in claim 32, the temperature-indicating element being a foil, a patch, a transparent window or a security thread.

34. The method as claimed in claim 32, the temperature-indicating element being completely incorporated into the document, or partially incorporated thereinto.

35. The method as claimed in claim 20, said at least one thermochromic element being printed on the document and/or on the temperature-indicating element.

36. The method as claimed in claim 20, the security document comprising a plurality of thermochromic elements.

37. A security document, comprising:
at least one thermochromic element able to change appearance at least at one predefined temperature; and
at least one indication on the document, associated with said at least one thermochromic element, giving information on the change-of-appearance temperature of said at least one thermochromic element.

38. A security document, comprising:
a temperature-indicating element extending from one edge of the security document to the other and comprising at least one thermochromic element able to change appearance at a predefined temperature; and
at least one indication associated with said at least one thermochromic element, giving information on the change-of-appearance temperature of said at least one thermochromic element.

39. A security document, comprising:
one or more thermochromic elements all changing appearance at one and only one predefined temperature;
at least one indication on the document, associated with the thermochromic element or elements, giving information on the one and only one change-of-appearance temperature of the thermochromic element or elements.
